(19) United States
(12) Patent Application Publication
(10) Pub. No.: US 2015/0032647 A1
(43) Pub. Date: Jan. 29, 2015

(54) SYSTEMS AND METHODS FOR MULTI-COMPONENT KIT INVENTORY MANAGEMENT

(71) Applicant: PLEYGO, INC., San Jose, CA (US)

(72) Inventor: Raanan Lachman, Los Gatos, CA (US)

(73) Assignee: PLEYGO, INC., San Jose, CA (US)

(21) Appl. No.: 13/951,382

(22) Filed: Jul. 25, 2013

(51) Int. Cl. G06Q 30/00

(52) U.S. Cl. CPC G06Q 30/018
USPC 705/317

(57) ABSTRACT

Systems, apparatuses, and methods for managing multi-component kit inventory are discussed herein. Some embodiments may include a system with a networked device including circuitry configured to determine a kit has been received subsequent from the kit being in a user's possession. The kit may include multiple individual units. In responsive to determining that the kit has been received, the circuitry may be configured to: determine a unit compliance threshold; determine whether the kit was received with enough of the units to exceed the unit compliance threshold; and in response to determining that the kit, as received, exceeded the unit compliance threshold, initiate a remedial action. The remedial action may include notifying the user that the kit as received exceeded the unit compliance threshold. Furthermore, the user may be charged and/or the kit may be replenished, replaced or corrected prior to being placed in recirculation.

### FIELD

Embodiments of the invention relate, generally, to techniques for networked based management of multi-component kit inventory.

### BACKGROUND

Networked environments such as the Internet allow consumers to shop for goods and other tangible items. The goods can be ordered online and shipped to a user's home using mail and/or other package delivery services. Likewise, a user can reject nonconforming goods and return them to the sender using the same package delivery services. In this regard, areas for improving current systems have been identified.

### BRIEF SUMMARY

Through applied effort, ingenuity, and innovation, solutions to improve such systems have been realized and are described herein. In general, techniques are provided to facilitate management of multi-component kits for temporary and/or permanent use. A “multi-component kit,” as used herein, refers to a kit including multiple, and often numerous, units and/or non-unit components. In some embodiments, the units can include building blocks that are designed to be assembled together into an item. For example, the multi-component kit can be a building block set, including connectable blocks that can be mechanically coupled and uncoupled to each other for assembly into a toy, structure, vehicle, or other type of item. Additionally or alternatively, the multi-component kit can include non-unit components that are not assembled together. The non-unit components may include an instruction manual for assembling the units, a container (e.g., plastic bag) for the units, a user/machine-readable label including information about the multi-component kit, among other things. In some embodiments, the multi-component kit may include one or more toy cars and units of a racetrack that can be assembled for use with the cars. As yet another example, the multi-component kit can include dolls and units that can be assembled into a dollhouse. In yet other embodiments, the multi-component kit may include only non-unit components, such as dolls, toy trains, racecars, and/or other items that are not configured to be assembled together.

One concern for a business or other entity that owns these kits relates to how to determine (e.g., in a cost effective, scalable and efficient manner) whether multi-component kits, including building blocks, toy cars and/or dolls, are sufficiently complete when returned from a user after being in the user's possession for a period of time. For example, a multi-component kit may be deemed incomplete when returned if too many units are missing and/or when even one key non-unit component is missing.

Another concern relates to how to resolve losses after a kit is returned to the owner with an insufficient number of components. As such, some embodiments discussed herein provide systems, apparatuses, and methods for providing, collecting, accounting for, and resolving the loss of components (such as building block, toy cars, etc.) of a multi-component kit that has been returned by a user to the owner.

Some embodiments may provide for a system configured to inventory multi-component kits. The system may include a networked device with circuitry configured to determine a kit has been received subsequent from the kit being in a user's possession, wherein the kit is associated with a plurality of individual units. In response to determining that the kit has been received, the circuitry may be further configured to: determine a unit compliance threshold; determine whether the kit was received with enough of the units to exceed the unit compliance threshold; and in response to determining the kit as received exceeded the unit compliance threshold, initiate a remedial action, wherein the remedial action includes notifying the user that the kit as received exceeded the unit compliance threshold.

In some embodiments, the unit compliance threshold may be based on one or more of: weight of the kit as sent and weight of the kit as received; and number of units included in the kit as sent and number of units included in the kit as received.

In some embodiments, the remedial action may include one or more of: charging the user a fee; charging the user a fee based on the cost of one or more missing units; charging the user a fee based on the cost of one or more replacement units; sending an order to a manufacturer of the kit for one or more replacement units; and associating one or more replacement units with the kit (e.g., to replace the one or more missing units).

In some embodiments, the circuitry may be further configured to associate the kit with one or more of: barcode data, a kit identification number, a user identification number, a shipping date, and a shipping weight of the kit.

In some embodiments, the system may further include a kit accounting apparatus. The kit accounting apparatus may include: a kit input configured to receive at least a portion of units of the kit; and kit accounting circuitry configured to determine that one or more units are missing from the kit as returned based on the at least a portion of the units of the kit received by the kit input.

In some embodiments, the kit accounting apparatus may further include: one or more unit inputs configured to receive one or more replacement units; and a kit output configured to provide the units of the kit including the one or more replacement units. The kit accounting circuitry may be further configured to: determine the one or more replacement units by accessing kit data indicating the units of the kit; and associate the one or more replacement units with the kit after determining the one or more replacement units.

In some embodiments, the kit accounting apparatus may further include one or more sensors configured to determine one or more unit defining characteristics and quantity of units for the at least a portion of the units of the kit. The kit accounting circuitry may be further configured to determine that the one or more units are missing from the kit as returned based on the unit defining characteristics and the quantity of units.

In some embodiments, the one or more unit inputs of the kit accounting apparatus may be further configured to receive the units of the kit. The kit accounting circuitry may be further configured to: access kit data indicating the units of the kit; and control the one or more unit inputs based on the kit data. The kit output may be further configured to provide the units of the kit received from the one or more unit outputs.

In some embodiments, the circuitry of the networked device may be further configured to: receive an indication from a user device associated with the user that the kit is missing one or more units; and send an order to the manufacturer of the kit for the one or more units.

In some embodiments, the circuitry may be further configured to, in response to determining that the kit has been received: determine whether an instruction manual for the kit is missing from the kit; and print the instruction manual after determining that the instruction manual is missing from the kit.

In some embodiments, at least some of the units of the kit may be configured to mechanically couple to each other. For example, where the units are building blocks, the building blocks may be configured to mechanically couple to each other for assembly into an item. Furthermore, the instruction manual for the kit may indicate how to assemble the kit by mechanically coupling the units.

Some embodiments may provide for a method for inventorying multi-component kits. The method may include determining a kit has been received subsequent from the kit being in a user's possession, wherein the kit is associated with a plurality of individual units. In response to determining that the kit has been received, the method may further include: determining a unit compliance threshold; determining whether the kit was received with enough of the units to exceed the unit compliance threshold; and in response to determining the kit as received exceeded the unit compliance threshold, initiating a remedial action, wherein the remedial action includes notifying the user that the kit as received exceeded the unit compliance threshold. For example, the unit compliance threshold may be based on one or more of: weight of the kit as sent and weight of the kit as received; and number of units included in the kit as sent and number of units included in the kit as received.

In some embodiments, the remedial action may include one or more of: charging the user a fee; charging the user a fee based on the cost of one or more missing units; charging the user a fee based on the cost of one or more replacement units; sending an order to a manufacturer of the kit for one or more replacement units; and associating one or more replacement units with the kit.

In some embodiments, the method may further include associating the kit with one or more of: barcode data, a kit identification number, a user identification number, a shipping date, and a shipping weight of the kit.

In some embodiments, the method may further include: receiving at least a portion of units of the kit; and determining that one or more units are missing from the kit as returned based on the at least a portion of the units of the kit. The method may further include: determining one or more replacement units by accessing kit data indicating the units of the kit; associating the one or more replacement units with the kit after determining the one or more replacement units; receiving the one or more replacement units; and providing the units of the kit including the one or more replacement units.

In some embodiments, the method may further include: receiving one or more unit defining characteristics and quantity of units for the at least a portion of the units of the kit; and determining that the one or more units are missing from the kit as returned based on the unit defining characteristics and the quantity of units.

In some embodiments, the method may further include: accessing kit data indicating the units of the kit; receiving the units of the kit from one or more unit inputs of a kit accounting apparatus; and providing the units of the kit received from the one or more unit inputs.

In some embodiments, the method may further include: receiving an indication from a user device associated with the user that the kit is missing one or more units; and sending an order to the manufacturer of the kit for the one or more units.

In some embodiments, the method may further include: determining whether an instruction manual for the kit is missing from the kit; and printing the instruction manual after determining that the instruction manual is missing from the kit.

In some embodiments, at least some of the units are configured to mechanically couple to each other. Furthermore, the instruction manual for the kit may indicate how to assemble the kit by mechanically coupling the units.

Some embodiments may include circuitry and/or media configured to implement the methods and/or other functionality discussed herein. For example, one or more processors, and/or other machine components may be configured to implement the functionality discussed herein based on instructions and/or other data stored in memory and/or other non-transitory computer readable media.

These characteristics as well as additional features, functions, and details of various embodiments are described below. Similarly, corresponding and additional embodiments are also described below.

### BRIEF DESCRIPTION OF THE DRAWINGS

Having thus described some embodiments in general terms, reference will now be made to the accompanying drawings, which are not necessarily drawn to scale, and wherein:

FIG. 1 shows an example system in accordance with some embodiments;

FIG. 2 shows an example kit accounting system in accordance with some embodiments;

FIG. 3 shows example circuitry in accordance with some embodiments;

FIG. 4 shows an example of a method for adding a kit to a user shipment queue performed in accordance with some embodiments;

FIG. 5 shows an example of a method for updating a user shipment queue performed in accordance with some embodiments;

FIG. 6 shows an example of a method for providing a kit performed in accordance with some embodiments;

FIG. 7 shows an example of a method for accounting for a kit returned from a user performed in accordance with some embodiments;

FIG. 8 shows an example of a method for providing remedial action for a received kit performed in accordance with some embodiments; and

FIG. 9 shows an example of a method for replacing components of a kit performed in accordance with some embodiments.

### DETAILED DESCRIPTION

Embodiments will be described more fully hereinafter with reference to the accompanying drawings, in which some, but not all embodiments contemplated herein are shown. Indeed, various embodiments may be implemented in many different forms and should not be construed as limited to the embodiments set forth herein; rather, these embodiments are provided so that this disclosure will satisfy applicable legal requirements. Like numbers refer to like elements throughout.

As used herein, the terms “data,” “content,” “information” and similar terms may be used interchangeably to refer to data capable of being captured, transmitted, received, displayed and/or stored in accordance with various example embodiments. Thus, use of any such terms should not be taken to limit the spirit and scope of the disclosure. Further, where a device is described herein to receive data from another device, it will be appreciated that the data may be received directly from the another device or may be received indirectly via one or more intermediary devices, such as, for example, one or more servers, relays, routers, network access points, base stations, and/or the like, sometimes referred to herein as a “network.” Similarly, where a device is described herein to send data to another device, it will be appreciated that the data may be sent directly to the another device or may be sent indirectly via one or more intermediary devices, such as, for example, one or more servers, relays, routers, network access points, base stations, and/or the like.

As used herein, the term “method” refers to one or more steps that may be performed by a device, apparatus, system, circuitry, one or more processors, or the like. Where an example method is shown as including more than one step, it will be appreciated that the steps may be performed in different orders than as shown in the example and that not all steps are necessarily required. Furthermore, the methods are described herein as being performed by example structures for clarity and are not limited to those structures (e.g., a particular server, device, apparatus, etc.) in some embodiments.

### Brief Overview

Methods, systems, apparatus and computer program products described herein are operable for providing multi-component kits for rent to users. Various embodiments may include techniques for providing kits for shipment as well as collection, accounting and loss resolution for received kits. For example, a kit may be received from the user subsequent to user possession with one or more defects, such as missing, damaged, and/or especially worn components. Some embodiments may provide for techniques for taking remedial actions to rectify the defects of the multi-component kit. For example, a determination can be made as to which components are missing and remedial action to replace the missing components may be performed. Example remedial actions for a missing component may include notifying the user, charging the user a fee, replacing the one or more missing components (e.g., prior to recirculation of the kit), and/or conducting other anti-loss activities.

To avoid overcomplicating the discussion, many examples provided herein are discussed in the context of replacing missing units, but embodiments discussed herein may be configured to identify and rectify other imperfections of multi-component kits, including damaged and/or uncharacteristically worn components. For example, a multi-component kit having dolls may be returned with one of the dolls' hair being cut and/or stained, and embodiments discussed herein can be configured to detect the damage to the doll and execute remedial action to rectify the multi-component kit's imperfection (e.g., replace the doll, charge the user a fee, replace the doll's hair, etc.).

### Exemplary System Architecture

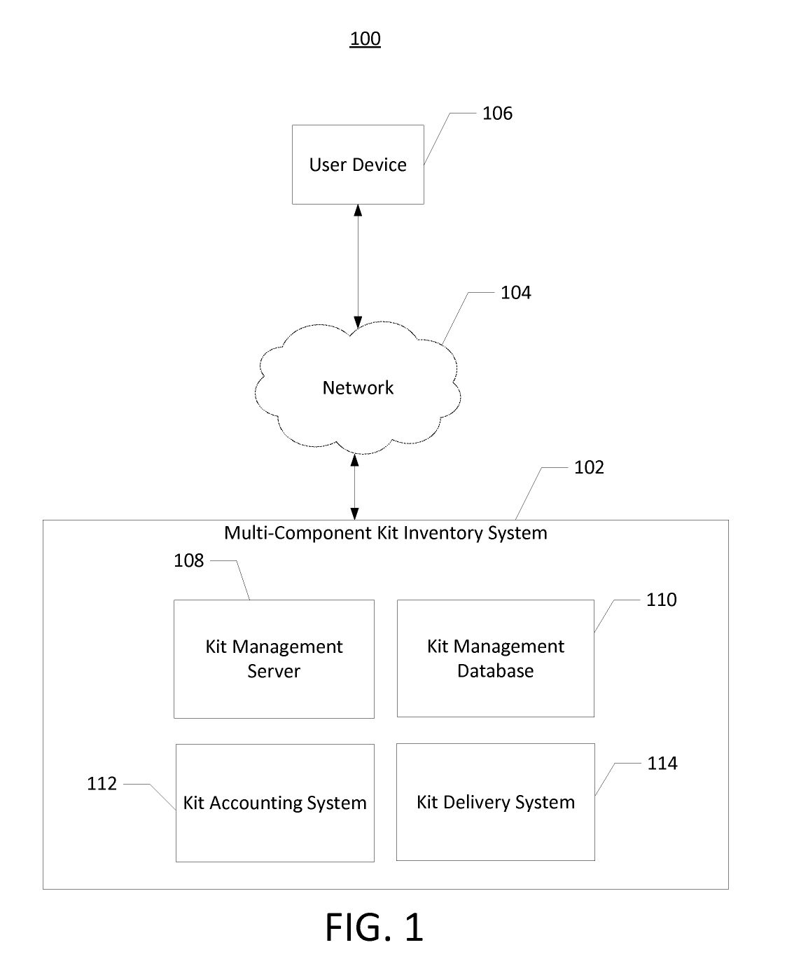

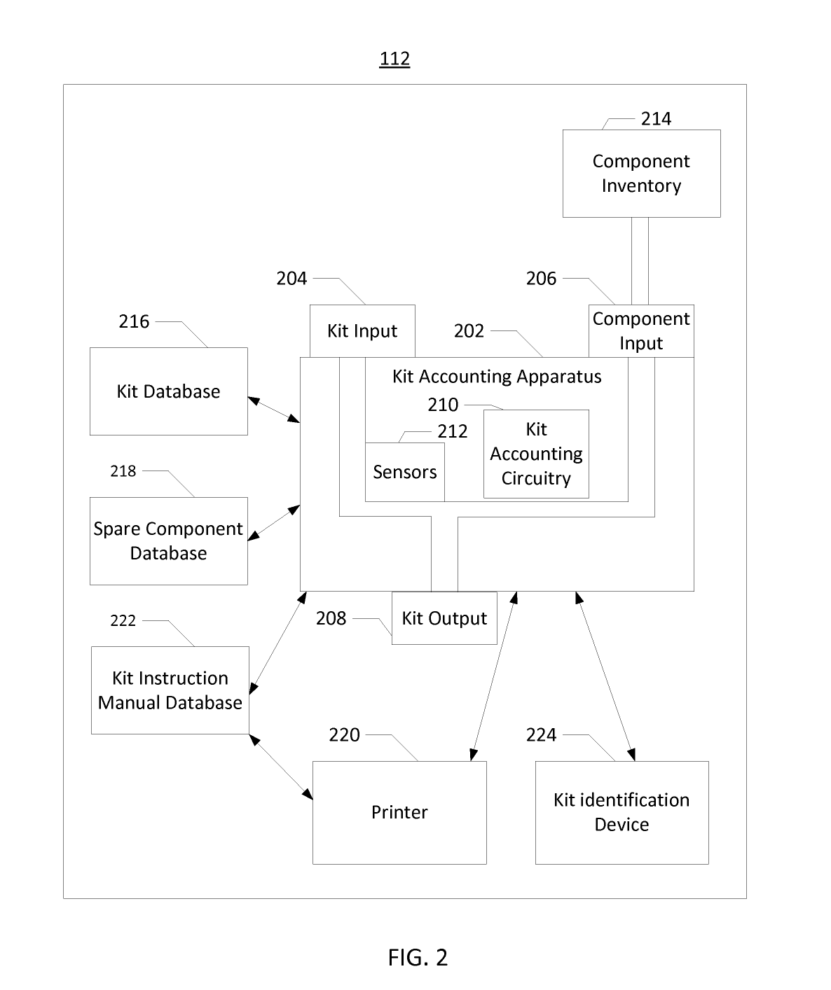

FIG. 1 shows an example system 100, in accordance with some embodiments. System 100 may include multi-component kit inventory system 102 (or “system 102”), network 104, and user device 106. System 102 may be communicably connected with user device 102 via network 104. System 102 may include kit management server 108, kit management database 110, kit accounting system 112 and kit delivery system 114. As discussed in greater detail with respect to FIG. 2, kit accounting system 112 may be configured to provide backend functionality related to kit collection, accounting, and/or loss resolution. In some embodiments, kit accounting system 112 may further be configured to provide kit assembly and checkout related functionality. Kit delivery system 114 may include a physical storage space for kits and a physical delivery system for kits to provide kits to users. Kit delivery system 114 may include one or more servers, apparatuses, or other circuitry implementing machines configured to communicate with kit management server 108 and/or kit accounting system 112.

Kit management server 108 may include circuitry, networked processors, or the like configured to perform some or all of the server-based processes described herein and may be any suitable network server and/or other type of processing device. For example, kit management server 108 may be configured to provide user interfaces for updating user shipment queues, accessing user accounts, browsing, selecting, adding or deleting kits (available or otherwise), and/or other front end functionality between system 102 and user device 106. In some embodiments, system 102 may function as a “cloud” with respect to the user device 106. For example, kit management server 108 may include several servers performing interconnected and/or distributed functions. To avoid unnecessarily overcomplicating the disclosure, kit management server 108 is shown and described herein as a single server.

Kit management database 110 may be any suitable network storage device configured to store some or all of the information described herein. Kit management database 110 may be configured to store user information such as user queue data, user account data, user subscription and/or account level, etc. Furthermore, kit management database 110 may also be configured to store kit data accessible to user device 106 that indicates kits available for rent and/or other kits information which might be available to rent at a future time. For example, kit management database 110 may include one or more database systems, backend data servers, network databases, cloud storage devices, etc. To avoid unnecessarily overcomplicating the disclosure, kit management database 110 is shown and described herein as a single database.

Network 104 may include one or more wired and/or wireless communication networks including, for example, a wired or wireless local area network (LAN), personal area network (PAN), metropolitan area network (MAN), wide area network (WAN), or the like, as well as any hardware, software and/or firmware for implementing the one or more networks (such as, e.g., network routers, switches, hubs, etc.). For example, network 104 may include a cellular telephone, mobile broadband, long term evolution (LTE), GSM/EDGE, UMTS/HSPA, IEEE 802.11, IEEE 802.16, IEEE 802.20, WiFi, dial-up, and/or WiMax network. Furthermore, network 104 may include a public network, such as the Internet, a private network, such as an intranet, or combinations thereof, and may utilize a variety of networking protocols now available or later developed including, but not limited to TCP/IP based networking protocols.

User device 106 may be associated with a user, such as a consumer with an account provided by system 102. Although a single user device 106 is shown, system 100 may include any number of user devices that may be associated with various other users. User device 106 may be a mobile device and/or a stationary device. For example, user device 106 may be a mobile device such as a cellular telephone (including smartphones and/or other types of mobile telephones), laptop, tablet, electronic reader, e-book device, media device, and/or the like. Additionally and/or alternatively, user device 106 may be a stationary device such as a desktop computer, work station, point-of-sale device, or the like.

FIG. 2 shows an example kit accounting system 112 in accordance with some embodiments. Kit accounting system 112 may be configured to provide kit assembly (e.g., prior to user delivery) and/or collection, accounting, and/or loss resolution (e.g., following user return). In some embodiments, kit accounting system 112 may include kit accounting apparatus 202. Kit accounting apparatus 202 may include kit accounting circuitry 210, which may be configured to perform some or all of the backend techniques discussed herein for kit inventory management, including accounting and remedial actions for correcting defects and/or imperfections in the multi-component kit that exceed a predefined threshold, such as by identifying and replacing missing components (e.g., units and non-unit components) of returned kits.

In some embodiments, kit accounting system 112 may further include component inventory 214, kit database 216, spare component database 218, printer 220, kit instruction manual database 222, and kit identification device 224. Kit accounting apparatus 202 may be configured to assemble/disassemble a kit, determine defects and/or imperfections in a returned kit, replace components of a kit, replace spare components (e.g., spare units) associated with a kit, and/or provide other accounting functionality of kits' components. Kit accounting apparatus 202 may include kit input 204 for receiving a returned kit, component input 206 for receiving one or more components of a kit, sensors 212 for determining one or more missing components from the returned kit, kit output 208 for providing a complete kit, and kit accounting circuitry 210 for controlling the functionality of kit accounting apparatus 202.

For example, kit accounting apparatus 202 may be configured to provide a full kit from components in components inventory 214. Kit accounting circuitry 210 may receive kit data from kit database 216 indicating the components of the kit. Via control of component input 206 and/or component inventory 214, the components of the kit may be received from component inventory 214 at component input 206 and output to kit output 208. In some embodiments, kit accounting apparatus 202 may also or instead be configured to disassemble kits that are assembled or partially assembled, such as an assembled kit placed at kit input 204 (e.g., after being returned by a user).

In another example, a returned kit may be placed (e.g., the units of the kit in a dissembled state) in kit input 204. Sensors 212, which may include one or more suitable sensors for determining defects and/or imperfections of the multi-component kit by analyzing characteristics of one or more of the kit's component defining characteristics (e.g., shape, color, size, weight, volume, thermal signature and quantity of components). For example, sensors 212 may include a scale or other mass analyzing sensor configured to determine missing components. As such, sensor 212 can be configured to produce weight data that circuitry 210 can be configured to interpret to determine whether components are missing based the return weight being lower than the weight when shipped to the user. As another example, sensor 212 can include a liquid displacement sensor, wherein the kits' components may be submerged into a liquid (such as a cleaning solution, antibacterial chemical and/or other disinfectant) and sensor 212 can generate output data indicating how much liquid has been displaced. Circuitry 210 could then be configured to determine whether components are missing from the kit based on how much liquid was displaced. As yet another example, sensor 212 may include one or more optical, electromagnetic (e.g., radio frequency identification (RFID), volume, thermal signature and/or any other type of sensors configured to generate output data that can be interpreted by circuitry 210.

In some embodiments, after determining there are one or more defects and/pr imperfections in the kits' components, such as one or more missing components, kit accounting apparatus 202 may be configured to provide one or more replacement components to the kit. For example, the one or more replacement components may be received from component inventory 214 via component input 206, combined with the returned components of the kit and output at kit output 208.

In some embodiments, kit accounting apparatus 202 may also be configured to assemble, account, and/or replace spare component sets. For example, a kit may be associated with one or more spare components that form a spare component set. The one or more spare components, for example, may include a set of the most common units of a kit and/or across multiple kits. Here, kit accounting circuitry 210 may be configured to receive spare component data from spare component database 218 and/or receive the one or more spare components from component inventory 214. Furthermore, a returned spare component set may be placed into kit input 204, where sensors 212 may be configured to determine which spare components to request from component inventory 214. Once a spare component set is assembled and/or its missing spare components replaced, the spare component set may also be output from kit accounting apparatus 202 at kit output 208.

In some embodiments, the kits can include non-unit components, such as instructional manuals describing a recommended manner of assembling the kits' units into an item, illustrating use and/or functionality of the kit, or the like. In addition to or instead of instructional manuals, some embodiments may be configured to include other types of components in the kits that are separate from and different than the kits' units. A database may be maintained for one or more of these other types of components. For example, kit instruction manual database 222 may be configured to store kit instruction manual information for each kit. An instruction manual may be printed from the manual information and then included with the kit. In some embodiments, a replacement kit instructional manual can be printed by printer 220 in response to circuitry 210 determining the instruction manual is missing from a particular kit (e.g., upon receipt from a user and/or before shipping the kit to a user). In some embodiments, kit instruction manual database 222 may be further configured to store electronic instruction manuals, such as video instructions that may be sent to user device 106.

Kit identification device 224 may be configured to provide kit identification. In some embodiments, kit identification device 224 may include a barcode scanner. For example, a barcode indicating barcode data may be included (e.g., via a label generated by printer 220) onto packaging of a kit. Prior to delivery to a user and subsequent to return from the user, the kit may be scanned with barcode scanner 224 to identify the kit. In some embodiments, the barcode data may be associated with a kit identifier, a user identifier, a shipping date, a scan in date, a weight of the kit (e.g., both prior to delivery and upon return), and/or any other kit or user information. The barcode data and its associations may be stored in kit database 216, kit management database 110, and/or in any other non-transitory storage medium accessible by circuitry 210. In some embodiments, kit identification device 224 may include a radio frequency identification (RFID) reader, a magnetic stripe reader, and/or any other suitable device for kit identification.

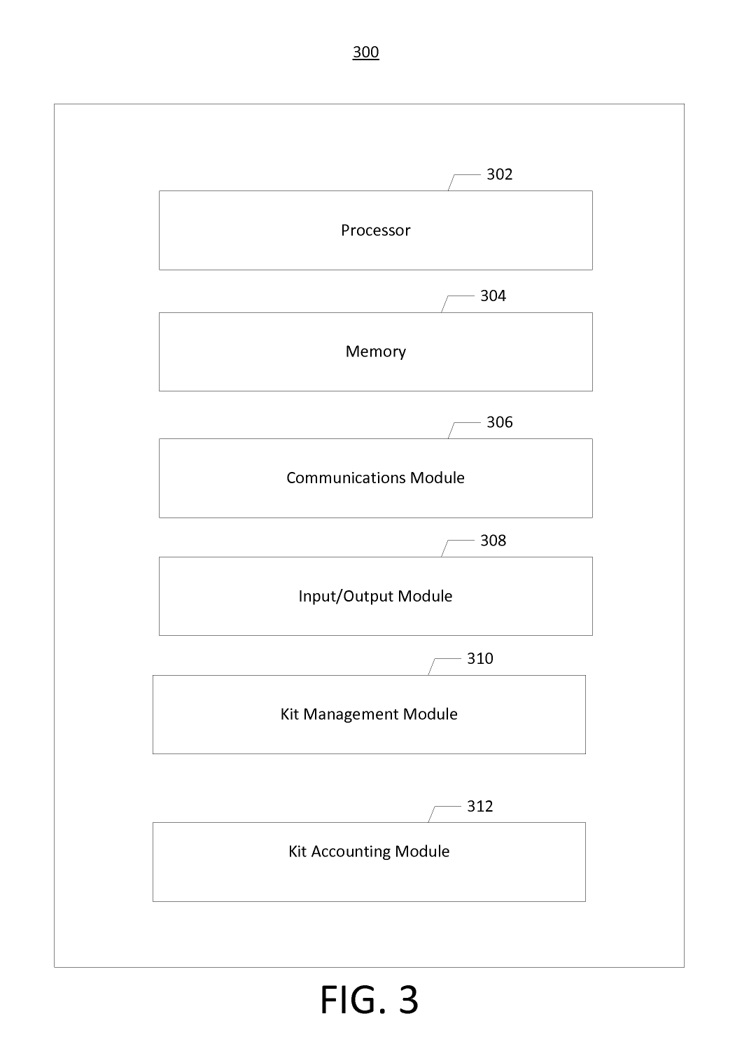

FIG. 3 shows a schematic block diagram of example circuitry 300, some or all of which may be included in system 102, server 108, database 110, user device 106, kit accounting system 112, kit accounting apparatus 202, kit database 216, spare component database 218, printer 220, kit instruction manual database 222 and/or kit identification device 224. In accordance with some example embodiments, circuitry 300 may include various means, such as one or more processors 302, memories 304, communications modules 306, and/or input/output modules 308.

In some embodiments, such as when circuitry 300 is included in system 102, kit management module 310 and/or kit accounting module 312 may also or instead be included. As referred to herein, “module” includes hardware, software and/or firmware configured to perform one or more particular functions. In this regard, the means of circuitry 300 as described herein may be embodied as, for example, circuitry, hardware elements (e.g., a suitably programmed processor, combinational logic circuit, integrated circuit, and/or the like), a computer program product comprising computer-readable program instructions stored on a non-transitory computer-readable medium (e.g., memory 304) that is executable by a suitably configured processing device (e.g., processor 302), or some combination thereof.

Processor 302 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 3 as a single processor, in some embodiments, processor 302 may comprise a plurality of processing means. The plurality of processing means may be embodied on a single computing device or may be distributed across a plurality of computing devices collectively configured to function as circuitry 300. The plurality of processing means may be in operative communication with each other and may be collectively configured to perform one or more functionalities of circuitry 300 as described herein. In an example embodiment, processor 302 may be configured to execute instructions stored in memory 304 or otherwise accessible to processor 302. These instructions, when executed by processor 302, may cause circuitry 300 to perform one or more of the functionalities described herein.

Whether configured by hardware, firmware/software methods, or by a combination thereof, processor 302 may comprise an entity capable of performing operations according to embodiments of the present invention while configured accordingly. Thus, for example, when processor 302 is embodied as an ASIC, FPGA or the like, processor 302 may comprise specifically configured hardware for conducting one or more operations described herein. As another example, when processor 302 may be embodied as an executor of instructions, such as may be stored in memory 304, the instructions may specifically configure processor 302 to perform one or more algorithms, methods or operations described herein. For example, processor 302 may be configured to execute operating system applications, firmware applications, media playback applications, media editing applications, among other things.

Memory 304 may comprise, for example, volatile memory, non-volatile memory, or some combination thereof. Although illustrated in FIG. 3 as a single memory, memory 304 may comprise a plurality of memory components. The plurality of memory components may be embodied on a single computing component or distributed across a plurality of computing components. In various embodiments, memory 304 may comprise, for example, a hard disk, random access memory, cache memory, flash memory, a compact disc read only memory (CD-ROM), solid state memory, digital versatile disc read only memory (DVD-ROM), an optical disc, circuitry configured to store information, integrated circuitry, chemical/biological memory, paper, or some combination thereof. Memory 304 may be configured to store information, data, applications, instructions, or the like for enabling circuitry 300 to carry out various functions in accordance with example embodiments discussed herein. For example, in at least some embodiments, memory 304 may be configured to buffer input data for processing by processor 302. Additionally or alternatively, in at least some embodiments, memory 304 may be configured to store program instructions for execution by processor 302 and/or data for processing by processor 302. Memory 304 may store information in the form of static and/or dynamic information. This stored information may be stored and/or used by circuitry 300 during the course of performing its functionalities.

Communications module 306 may be embodied as any component or means embodied in circuitry, hardware, a computer program product comprising computer readable program instructions stored on a computer readable medium (e.g., memory 304) and executed by a processing device (e.g., processor 302), or a combination thereof that is configured to receive and/or transmit data from/to another device, such as, for example, a second circuitry 300 and/or the like. In some embodiments, communications module 306 (like other components discussed herein) can be at least partially embodied as or otherwise controlled by processor 302. In this regard, communications module 306 may be in communication with processor 302, such as via a bus. Communications module 306 may include, for example, an antenna, a transmitter, a receiver, a transceiver, network interface card and/or supporting hardware and/or firmware/software for enabling communications. Communications module 306 may be configured to receive and/or transmit any data that may be stored by memory 304 using any protocol that may be used for communications. Communications module 306 may additionally and/or alternatively be in communication with the memory 304, input/output module 308 and/or any other component of circuitry 300, such as via a bus. Communications module 306 may be configured to use one or more communications protocols such as, for example, Wi-Fi (e.g., a 802.11 protocol, Bluetooth, etc.), radio frequency systems (e.g., 900 MHz, 1.4 GHz, and 5.6 GHz communication systems), infrared, GSM, GSM plus EDGE, CDMA, quadband, and other cellular protocols, VOIP, or any other suitable protocol

Input/output module 308 may be in communication with processor 302 to receive an indication of an input and/or to provide an audible, visual, mechanical, or other output. For example, input/output module 308 may include means for performing analog-to-digital and/or digital-to-analog data conversions. Input/output module 308 may include support, for example, for a display, touch screen, keyboard, button, click wheel, mouse, joystick, an image capturing device, microphone, speaker, biometric scanner, and/or other input/output mechanisms. In embodiments where circuitry 300 may be implemented as a server or database, aspects of input/output module 308 may be reduced as compared to embodiments where circuitry 300 may be implemented as an end-user machine or other type of device designed for complex user interactions. In some embodiments (like other components discussed herein), input/output module 308 may even be eliminated from circuitry 300. Alternatively, such as in embodiments wherein circuitry 300 is embodied as a server or database, at least some aspects of input/output module 308 may be embodied on an apparatus used by a user that is in communication with circuitry 300. Input/output module 308 may be in communication with memory 304, communications module 306, and/or any other component(s), such as via a bus. Although more than one input/output module and/or other component can be included in circuitry 300, only one is shown in FIG. 3 to avoid overcomplicating the disclosure (e.g., like the other components discussed herein).

In some embodiments, kit management module 310 and/or kit account module 312 may also or instead be included and configured to perform the functionality discussed herein related to front end and backend kit management, respectively. In some embodiments, some or all of the functionality of modules 310 and/or 312 may be performed by processor 302. In this regard, the example processes and algorithms discussed herein can be performed by at least one processor 302, module 310 and/or module 312. For example, non-transitory computer readable storage media can be configured to store firmware, one or more application programs, and/or other software, which include instructions and other computer-readable program code portions that can be executed to control processors of the components of system 300 to implement various operations, including the examples shown above. As such, a series of computer-readable program code portions may be embodied in one or more computer program products and can be used, with a device, server, database, and/or other programmable apparatus, to produce the machine-implemented processes discussed herein.

Any such computer program instructions and/or other type of code may be loaded onto a computer, processor or other programmable apparatus's circuitry to produce a machine, such that the computer, processor other programmable circuitry that executes the code may be the means for implementing various functions, including those described herein. In some embodiments, one or more external systems (such as a remote cloud computing and/or data storage system) may also be leveraged to provide at least some of the functionality discussed herein.

As described above and as will be appreciated based on this disclosure, various embodiments may be implemented as methods, mediums, devices, servers, databases, systems, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Any suitable computer-readable storage medium may be utilized including non-transitory hard disks, CD/DVD-ROMs, flash memory, optical storage devices, quantum storage devices, chemical storage devices, biological storage devices, magnetic storage devices, etc.

Embodiments have been described above with reference to block diagrams of components, such as functional modules, system components and circuitry. Below is a discussion of an example process flowcharts describing functionality that may be implemented by one or more components discussed above. Each block of the diagrams and process flowcharts, and combinations of blocks diagrams and process flowcharts, respectively, can be implemented by various means including computer program instructions. These computer program instructions may be loaded onto a general purpose computer, special purpose computer, or other programmable data processing apparatus, such as processor 302, to produce a machine, such that the computer program product includes the instructions which execute on the computer or other programmable data processing apparatus to create a means for implementing the functions specified in the flowchart block or block diagrams.

These computer program instructions may also be stored in a computer-readable storage device (e.g., memory 304) that can direct a computer or other programmable data processing apparatus to function in a particular manner, such that the instructions stored in the computer-readable storage device produce an article of manufacture including computer-readable instructions for implementing the function discussed herein. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions discussed herein.

Accordingly, blocks of the block diagrams and flowchart illustrations support combinations of means for performing the specified functions, combinations of steps for performing the specified functions and program instruction means for performing the specified functions. It will also be understood that each block of the block diagrams and process flowcharts, and combinations of blocks in the block diagrams and process flowcharts, can be implemented by special purpose hardware-based computer systems that perform the specified functions or steps, or combinations of special purpose hardware and computer instructions.

### Providing Multi-Component Kits

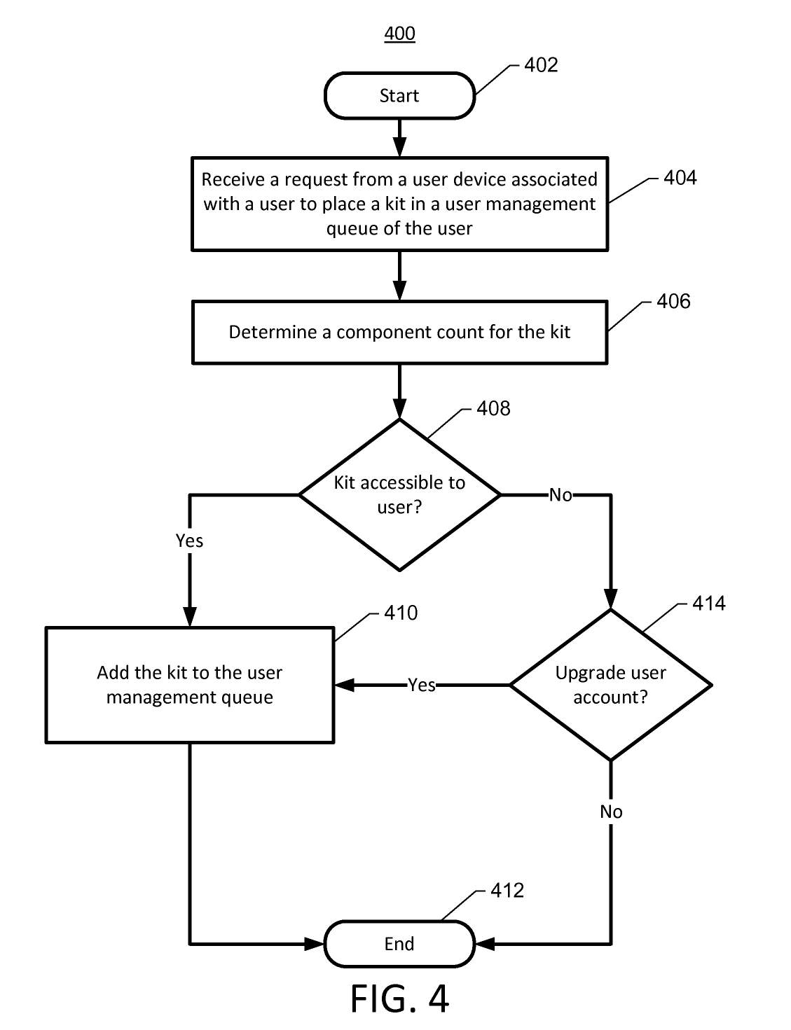

FIG. 4 shows an example of a method 400 for adding a kit to a user shipment queue performed in accordance with some embodiments. In some embodiments, method 400 may be performed by multi-component kit management inventory system 102 (e.g., kit management server 108), as shown in FIG. 1. Method 400 is described as being performed by kit management server 108, however, other suitable structures (e.g., one or more servers) may also be used in various embodiments. Furthermore, method 400 is described for clarity in a context where the kits are building block sets and the units are building blocks, although the method may be extended to other multi-component kits.

In some embodiments, kit management server 108 may be configured to associate each user (e.g., of user device 106) with a user account. The user account may provide the user with access to kit management services provided by system 102. In some embodiments, users may interact via system 102 with a variety of different user account models. For example, under a subscription model, a user account may be charged a flat fee per payment period (e.g., monthly) to keep a subscription with system 102. As discussed in more detail below, the subscription model may include limits on the number of kits that a user account can check out at a single time. Furthermore, the subscription model may include different subscription levels, and corresponding subscription fee levels, that provide varying levels of access to kits (e.g., by unit count, kit weight, number of concurrent kits checked out, etc.).

In another example, system 102 may be configured to operate a rental model for user accounts where users pay a rental fee each time they decide to rent a kit. Here, users may not be required to pay a subscription, sign-up, and/or other sort of access fee and/or such fees could be set lower than under a pure subscription module. Different kits may include different rental fees based on various factors such as the number of components of the kit, the weight of the kit, the popularity of the kit, the price of the kit, the availability of the kit, etc.

In a third example, system 102 may be configured to operate a trial model for user accounts. Here, a user may be allowed to purchase a kit after being provided possession of the kit. For example, kits could be provided for free (e.g., for a limited period of time and/or number of rentals) and/or under the subscription or rental models. For example, system 102 may provide support for a hybrid model including one or more of the account models. For example, a user under the subscription model that would normally not have access to a particular kit could also be allowed to rent the kit on a per use basis (e.g., by paying an additional price under the rental model). In another example, a user may purchase a kit while being in possession of the kit via the subscription model, in which case, a next kit in the user's user shipment queue may be provided to the user for rent.

Method 400 describes an example method for placing a kit in a user shipment queue, such as may be used under subscription model for user accounts. Method 400 may begin at 402 and proceed to 404, where kit management server 108 may be configured to receive a request from a user device associated with a user to place a kit in a user shipment queue of the user. The user shipment queue may indicate an ordered listing of kits that the user is interested in receiving. In some embodiments, kit management server 108 may be configured to provide (e.g., via network 104) user interfaces that may be accessed by user devices 106 for registration, account management, kit browsing, and user shipment queue management.

For example, user device 106, upon accessing an application, visiting a webpage, and/or otherwise contacting kit management server 108, may be provided with user interface displays that allow the user to browse kit data (e.g., as stored in kit management database 110) indicating kits that the user may be allowed to rent. The user, upon choosing to rent a particular kit, may be allowed to place the kit in the user shipment queue associated with the user account of the user. For example, the user shipment queue provides the user with a mechanism for indicating to kit management server 108 which kits to send the user and/or the order to send the kits. The user may be allowed to add, remove, and/or otherwise update the user shipment queue, such as upon accessing the user account by providing a username and password or some other identification and/or authentication mechanism.

At 406, kit management server 108 may be configured to determine a component count for the kit. For example, the component count for a building block set may be a unit count indicating the number of discrete building blocks (e.g., a building block count) that belong to the building block set. In some embodiments, kit data stored in kit management database 110 may be configured to store the component count for each block set. In the context of building blocks, the component count for the building block set provides an indication of the size of the set and/or value of the building block set. In some embodiments, the weight of the units, the cost of the units, and/or some other value factor could be used alternatively or in addition to the component count.

At 408, kit management server 108 may be configured to determine whether the kit is accessible to the user based on the component count for the kit. For example, the user's user account may be associated with a subscription level. In the context of building block sets, the subscription level may indicate a building block cap for building block sets that the user is allowed to rent (e.g., under the subscription model) and/or place in the user shipment queue. For example, a first subscription level may limit the user to building block sets with less than 300 building blocks, a second subscription level may limit the user to building block sets with less than 400 building blocks, and a third subscription level may place no limits on the number of building blocks in a set that the user may rent. Here, kit management server 108 may be configured to charge the user different fee amounts based on the subscription level.

In some embodiments, kit management server 108 may be configured to determine whether the kit is accessible to the user by comparing the subscription level of the user with the compare the component count for the kit. If the component count, for example, indicates that the kit has fewer components than the maximum allowed for the user's subscription level, the kit may be determined to be accessible to the user. If the component count indicates that the kit has more components than the maximum allowed for the user's subscription level, the component may be determined to be inaccessible to the user. In some embodiments, one or more other factors than component count may be used, such as weight of the kit, cost of the kit, availability of the kit, popularity of the kit, completeness of the kit, condition of kit, release date of the kit, and/or combinations thereof (e.g., weighted factors to generate a composite metric).

In response to determining that the kit is accessible to the user, method 400 may proceed to 410, where kit management server 108 may be configured to add the kit to the user shipment queue. For example, kit management server 108 may provide the user device a user shipment queue display in which one or more kits added by the user may be shown. Method 400 may then end at 412.

Returning to 408, in response to determining that the kit is inaccessible to the user, method 400 may proceed to 414, where kit management server 108 may be configured to determine whether the user would like to upgrade the user account. For example, kit management server 108 may indicate to user device 106 that the user subscription level is too low for the kit and/or may prompt the user to upgrade the user account. In some embodiments, one or more other rental models may be provided. For example, the user may be allowed to pay a rental fee for the kit that allows that kit to be placed in the user shipment queue and/or to be directly sent to the user on demand. In response to kit management server 108 determining that the user is not interested in upgrading the user account and/or otherwise becoming eligible to rent the kit, method 400 may proceed to 412 and end.

In response to kit management server 108 determining that the user is interested in upgrading the user account and/or otherwise becoming eligible to rent the kit, method 400 may return to 410, which the kit may be added to the user shipment queue. Method 400 may then proceed to 412 and end.

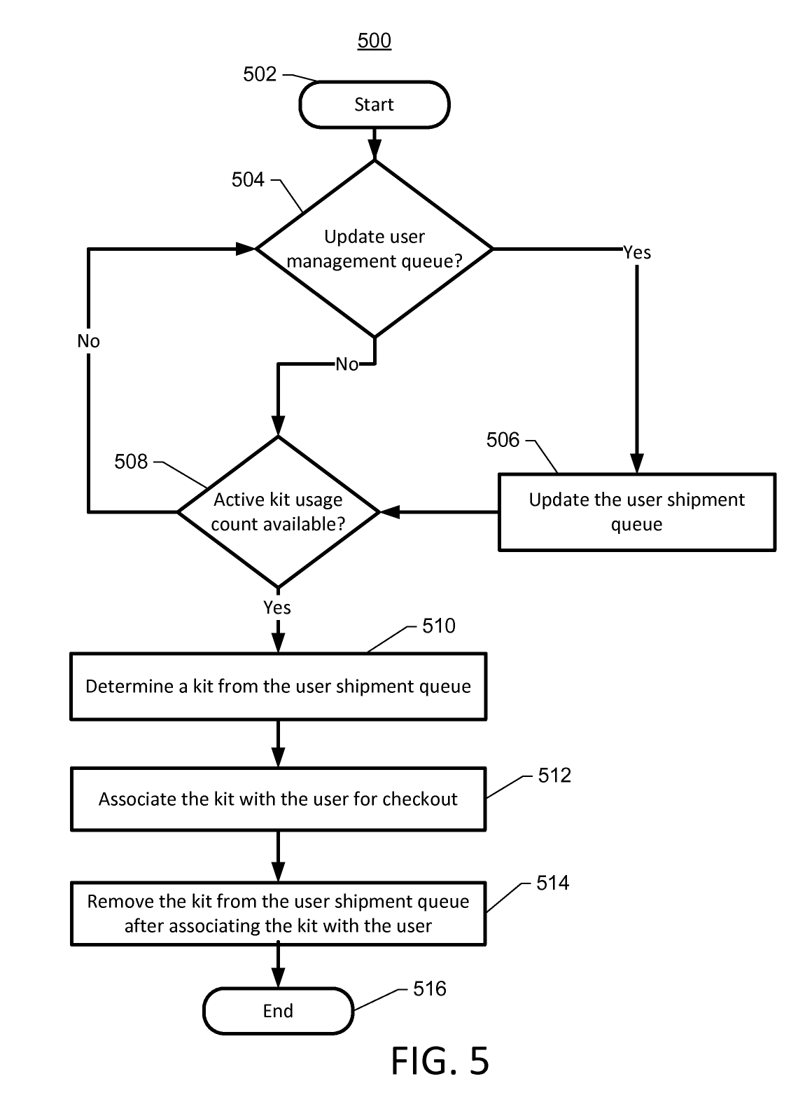

FIG. 5 shows an example of a method 500 for updating a user shipment queue, performed in accordance with some embodiments. Method 500 may be performed by kit management server 108, for example, to provide kits based on the user shipment queue.

Method 500 may begin at 502 and proceed to 504, where kit management server 108 may be configured to update a user shipment queue. As discussed above, user device 106 may be configured to allow a user to access a user account provide by kit management server 108. Furthermore, the user account may be associated with a user shipment queue including an ordered listing of kits. The user may be allowed, such as upon providing login credentials, to add kits, remove kits, reorder kits, and/or otherwise update the user shipment queue. In some embodiments, user shipment queues may also be updated based on kit data such as inventory count, availability of kits, availability of units of a kit, and/or any other factors that could, for example, make an offered kit placed in user queues become unavailable. In another example, user shipment queues may be updated based on a change associated with the user account, such downgraded subscription levels or the like.

In response to determining that to update the user shipment queue, the user shipment queue may be updated at 506. For example, the update may be based on instructions received from the user device 106 indicating that the user would like to place a particular kit at the top of the user shipment queue, meaning that the kit will be sent to the user in response to determining the user account is in a shipment-approved state.

If there are no updates to the user shipment queue, method 500 may then proceed to 508 (e.g., via 504 and/or 506), where kit management server 108 may be configured to determine whether a user account is in a shipment-approved state. In some embodiments, under a subscription model, each user account may be associated with an active kit usage counter indicating how many kits that a user is allowed to have checked out simultaneously. Upon the user checking out a kit, the user's checked out count may be increased and upon the user returning the kit, the user's active kit usage count may be decreased. As such, a user may have an active kit usage count of 3, indicating that the user must return a kit upon having three kits checked out before the user will be sent another kit in the user's shipment queue. In some embodiments, the user's subscription level or the like may allow users to have different active kit usage counts. For example, the highest subscription level may allow a user to have an active kit usage count of 5 while a lower subscription level may only have an active kit usage count of 3. If the user does not have an active kit usage count available, method 400 may return to 504.

If it is determined that the user account is in a shipment-approved state (e.g., that the user has an active kit usage count available), method 400 may then proceed to 510, where kit management server 108 may be configured to determine a kit from the user shipment queue. For example, the kit may be the top kit in the user shipment queue, as configured by the user at 506. In other examples, such as when a user is in a shipment-approved state but a queued kit is unavailable (e.g., temporarily out of inventory), the kit may be determined based on the next highest priority kit that is available.

At 512, kit management server 108 may be configured to associate the kit with the user for checkout. In some embodiments, kit management server 108 may first determine whether a copy of the kit is available in inventory. For example, kit management server 108 may be configured to communicate with kit management database 110 and/or kit database 216 to determine the inventory status of the kit. If the kit is determined to be in inventory, the kit may then be checked out to the user.

In some embodiments, each kit may be associated with barcode data. The barcode data may be generated by kit management server 108 and/or may be located on a label associated with the kit (e.g., on packaging of the kit). The barcode data may be associated with one or more of: a kit identification number, a user identification number, a shipping date, and a weight (e.g., shipping weight) of the kit. Upon a kit being checked out to the user, the user identification number of the user, the shipping date, and the weight may be recorded. For example, the kit may be pulled from inventory (e.g., stored at kit delivery system 114) and identified via a barcode on the packaging scanned by kit identification device 224. Via the scan, kit management server 108 may be configured to identify the kit by the kit identification number. In some embodiments, a spare component set (e.g., a spare building block bag) including one or more spare component and/or an instruction manual may be associated with the kit and/or placed in the same packaging as the kit (e.g., a first bag for the components of the kit and a second bag for the spare component set). Furthermore, one or more quality control steps may be performed by which the package (e.g., the kit, spare components, and/or instruction manual) may be checked for completeness and/or quality. The packaging may be physically closed and sealed. Prior to shipment, kit management server 108 may receive user identification number of the user, the shipping date, and/or the weight of the kit. The kit then be may be physically delivered to the user, such as via kit delivery system 114.

At 514, kit management server 108 may be configured to remove the kit from the user shipment queue after associating the kit with the user. For example, the top priority kit may be removed from the user shipment queue and the next highest priority kit may be moved to the top of the user shipment queue. Furthermore, delivery of the kit may be indicated via updating the user shipment queue, placing the kit in a user history display, sending a message (e.g., via email, text, etc.), and/or via any other notification technique. Method 500 may then end at 516.

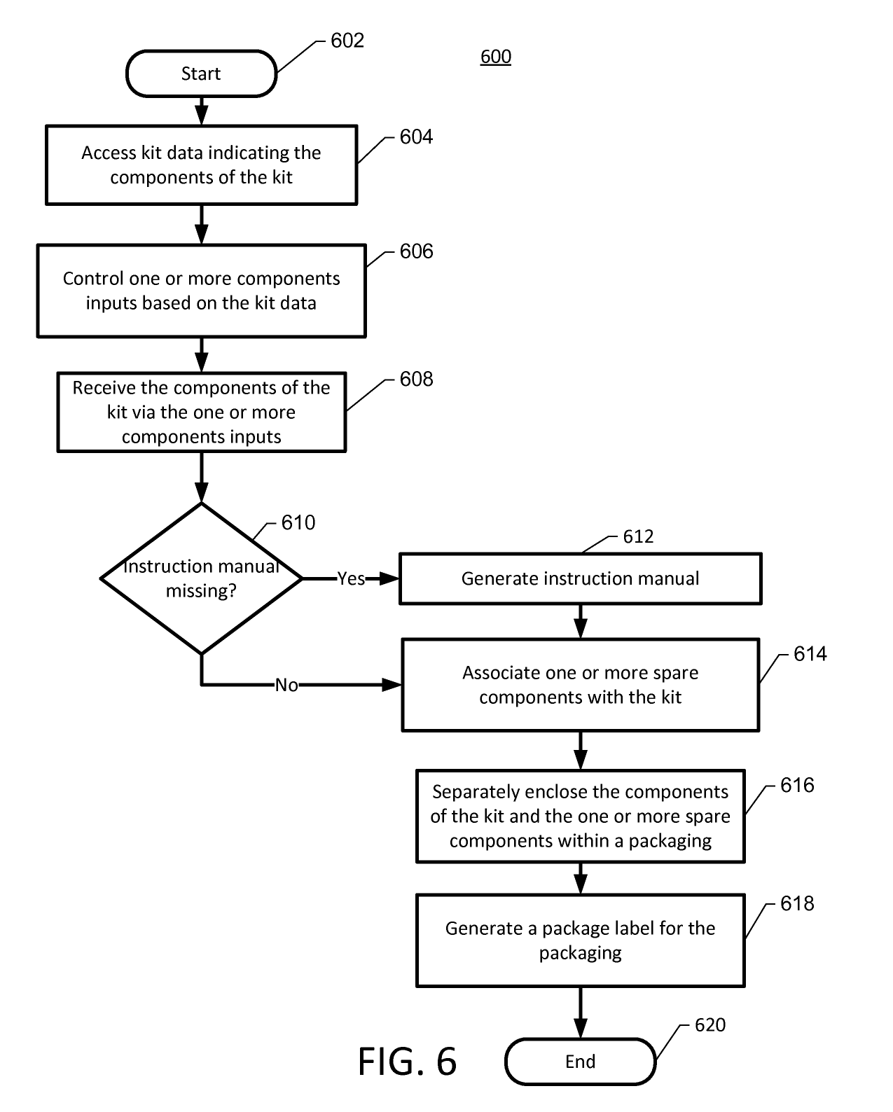

FIG. 6 shows an example of a method 600 for providing a kit, performed in accordance with some embodiments. Method 600 may provide for a dynamic technique for inventory management of multi-component kits, many of which may share interchangeable components in common (e.g., identical building blocks across multiple building block sets, the same instruction manuals, the same or similar dolls, etc.). Method 600 may be performed, for example at 512, to assemble a kit for delivery from its components upon associating the kit with the user for checkout. For clarity, method 600 is described as being performed by kit accounting system 112 (e.g., kit accounting apparatus 202 shown in FIG. 2).

Method 600 may begin at 602 and proceed to 604, where kit accounting circuitry 210 (or “circuitry 210”) of kit accounting apparatus 202 may be configured to access kit data indicating the components of the kit. For example, the kit data may be stored in kit database 216 and may indicate the component defining characteristics (e.g., unit defining characteristics such as size, color, shape, etc.) and quantity of components of the components of the kit. In another example, each component may be associated with an identification number or the like and the kit data may indicate one or more identification numbers for the components of the kit.

At 606, circuitry 210 may be configured to control one or more component inputs based on the kit data. For example, component input 206 may be connected with component inventory 214, which may include storage of component and/or kit inventories. Via control of component input 206. circuitry 210 may be configured to control component input 206, such as to open and/or close one or more component inputs 206 as determined by the kit data.

At 608, kit accounting apparatus 202 may be configured to receive the components of the kit via the one or more component inputs. For example, the components of the kit may be received automatically from component inventory 214 via the one or more component inputs 206. In some embodiments, kit accounting apparatus 202 may be configured to provide a temporary holding space for the kit as it is being assembled from its individual components. Once the components of the kit have been received, kit accounting apparatus may be configured to provide the kit, such as from kit output 208.

In some embodiments, rather than or in addition to being assembled from its components by kit accounting apparatus 202 or the like, the kit may be stored in inventory (e.g., within kit delivery system 114). Here, kit management server 108 and/or kit accounting system 112 may be configured to determine, upon a user requesting a kit, whether the kit is available in inventory. In response to determining that the kit is available in inventory, an alert, kit indicator and/or location indicator may be generated that alerts an employee or other user of system 102 to procure the kit for the user.

At 610, circuitry 210 may be configured to determine whether an instruction manual is missing from the kit. For example, each kit may be packaged with the instruction manual that provides a how-to guide for assembling the kit's item from the units, such as step-by-step instructions for connecting building blocks to form an item. In another example, the instruction manual may indicate recommended and/or proper use of the components. The instruction manual may be a physical document, and as such, may be missing from the kit upon being received from a user. In some embodiments, circuitry 210 may receive user input indicating that the instruction manual is missing upon a visual inspection of the kit packaging. Alternatively and/or additionally, the instruction manual may be provided to the user via electronic means, such as by way of network 104 to user device 106.

In response to determining that the instruction manual is missing from the kit, method 600 may proceed to 612, where circuitry 210 and/or kit management server 108 may be configured to generate the instruction manual. For example, instruction manuals may be stored in kit instruction manual database 222 and provided therefrom to printer 220 to create a physical copy of the instruction manual. In another example, an electronic copy of the instruction manual may be sent to user device 106 and/or written to a computer readable storage medium (e.g., flash drive, optical disc, memory, etc.) that is packaged with the kit.

In response to determining that the instruction manual is not missing from the kit, method 600 at 610 and/or after 612, method 600 may proceed to 614, circuitry 210 and/or kit management server 108 may be configured to associate one or more spare components with the kit. In some embodiments, the one or more spare components may be associated with the kit while being excluded from the component count for the kit (e.g., at 406 of method 400).

In some embodiments, the one or more spare components may include a collection of spare units determined to be the most helpful to user to assemble the item. Most helpful, as used herein, may include the units determined to be most commonly included in each kit (or some subset thereof) of the kits available for rent. In other examples, it may include the most commonly user requested replacement units (e.g., most commonly lost), most commonly missing units upon return from users, and/or combinations thereof. In some embodiments, complete spare component sets may be performed in a separate process from method 600 and a known complete spare component set may be associated with the kit at 614. Furthermore, spare component sets may be managed separately from kits in other ways. For example, the spare component set may be stored in a packaging that includes spare component barcode data associated with a spare component set identification number, a weight (e.g., shipping weight) of the spare component set, etc. Furthermore, upon checkout, the spare component barcode data may be further associated with a user identification number and a shipping date.

In some embodiments, circuitry 210 may be configured to assemble a spare component set from spare components stored in component inventory 214 using a method similar to method 600 at 604-608. For example, circuitry 210 may access spare component data within spare component database 218 to determine the one or more spare components to associate with the kit. Circuitry 210 may then be configured to control component input 206 and/or component inventory 214 to receive the one or more spare components. The one or more spare components may then be output at kit output 208. In some embodiments, the one or more spare components may be determined based on one or more (e.g., weighted) factors that may vary from kit to kit and/or over time (e.g., current availability of units).

At 616, the components of the kit and the one or more spare components may be separately enclosed within a packaging. For example, a building block set may be stored in a block set bag and a spare building block set may be stored in a spare building block bag (e.g., where the components are building blocks and the spare components are spare building blocks). Each bag may include a label or other indicia indicating their purpose and/or including instructions for use. For example, the spare building block set may include an instruction that the bag should only be opened when a building block is missing in the block set bag. Furthermore, the instructions may indicate to the user that a building block removed from the spare building block bag to complete assembly of an item should be returned with the block set bag rather than the spare building block bag.

At 618, circuitry 210 and/or kit management server 108 may be configured to generate a package label for the packaging. The packaging label may include a barcode associated with the barcode data. Furthermore, one or more other types of data may be included such as the kit identification number, the spare unit set identification number, the user identification number, the shipping date, and/or the weight kit and/or spare unit set. In some embodiments, circuitry 210 and/or kit management server 108 may be further configured to generate a shipping label and/or a return shipping label. The shipping label may be applied to the packaging and may be included with the packaging label or may be separate. The return shipping label may be printed to an adhesive and included within the packaging to provide pre-paid shipping for user for kit return. Method 600 may then end at 620.

### Collecting, Accounting and Remedial Action for Multi-Component Kits

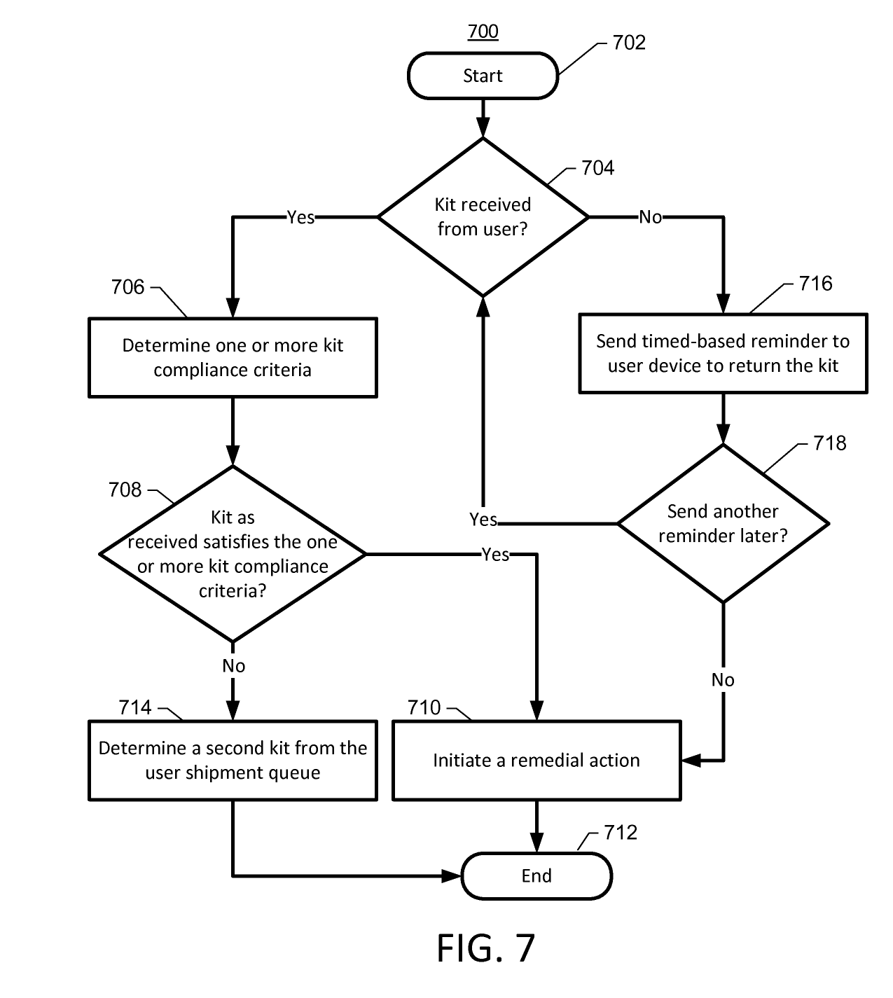

FIG. 7 shows an example of a method 700 for accounting for a kit returned from a user, performed in accordance with some embodiments. Method 700 may be performed upon a user returning a kit after the kit was in the user's possession. Method 700 is described herein as being performed by kit accounting system 112 and kit management server 108. In some other embodiments, method 700 may be performed by kit management server108 (e.g., where kit accounting system 112 is not used), kit accounting system 112, and/or with any other suitable circuitry.

Method 700 may begin at 702 and proceed to 704, where kit accounting system 112 may be configured to wait a predetermined period of time and periodically determine whether a kit was received from the user. Additionally or alternatively, upon physical return of the kit to kit delivery system 114 from the user, a determination may be made at 704 that the kit was received from the user (e.g., physically shipped back to the central processing site). For example, a kit may be identified as being in the possession of the central site in response to barcode data, radio frequency identifying data, and/or other identification data on the packaging of the kit being processed by kit identification device 224.

In response to determining that the kit has been received from the user at 704, method 700 may proceed to 706, where kit accounting system 112 may be configured to determine one or more kit compliance criteria. “Kit compliance criteria,” as used herein, may indicate various conditions for the received kit that when satisfied may trigger initiation of various remedial actions. An example of kit compliance criteria may include a component compliance threshold. The component compliance threshold may indicate the amount of components that may be missing from the kit before a remedial action is performed. For example, the component compliance threshold may be based on weight, such as that of the kit (e.g., the components) as sent compared with the weight of the kit as received. Alternatively and/or additionally, the component compliance threshold may be based on units and/or non-unit components, such as the number of components and/or number of a particular type of component included in the kit as sent compared with the number of components included in the kit as received. In some embodiments, the component compliance threshold may also depend on value of the missing components, which may be determined for example, based on determining each individual component missing from the received kit and their associated prices.

In some embodiments, the one or more kit compliance criteria may include criteria associated with component quality. For example, components that are damaged, excessively worn, dirty, or otherwise require attention may also be identified when the component quality falls below one or more component quality thresholds. In some embodiments, the one or more kit compliance criteria may include criteria associated with whether non-unit components of the kit are missing, damaged, excessively worn out from normal usage, or otherwise require replacement. Some example non-unit kit components may include packaging and/or shipping labels, packaging, kit handling/return instructions, or the like. As discussed in greater detail below, depending on the kit compliance criteria and the condition of the received kit, various remedial actions may be performed such as by notifying the user, replacing and/or repairing components, charging the user a fee, or the like.

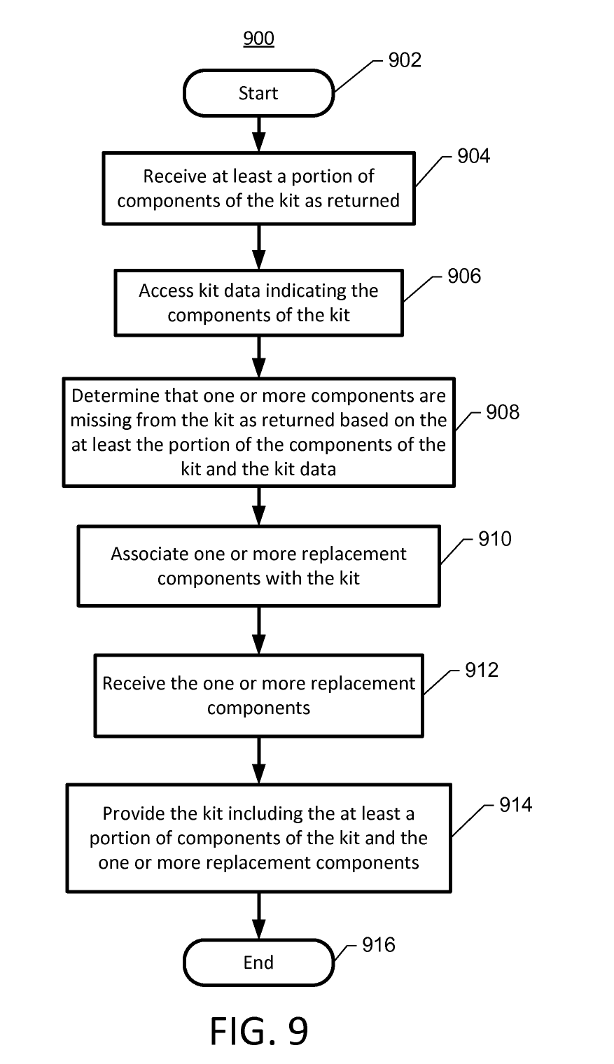

At 708, kit accounting system 112 may be configured to determine whether the kit as received satisfies the one or more kit compliance criteria. For example, kit accounting system 112 may be configured to determine whether the kit as received exceeds or fails to exceed the component compliance threshold. In some embodiments, where the component compliance threshold is based on weight, the received kit may be weighed and the received weight may be sent to kit account system 112. The received weight may then be compared with the shipping weight and/or other predetermined weight value to determine a weight difference. The weight difference may then be compared with the component compliance threshold. In some embodiments, where the component compliance threshold is based on number of components in the kit as received, one or more missing components may be determined. For example, the one or more missing components may be determined by comparing the received components with the components of the kit as sent. In some embodiments, the kit may be assembled to determine the one or more missing components. In some embodiments, kit accounting system 112 may be configured to perform accounting of the kit to determine automatically one or more missing components of the received kit by receiving the returned components, as discussed in greater detail in method 900 and FIG. 9. In some embodiments, kit accounting system 112 may be configured to determine whether the kit as received includes other defects and/or imperfections.

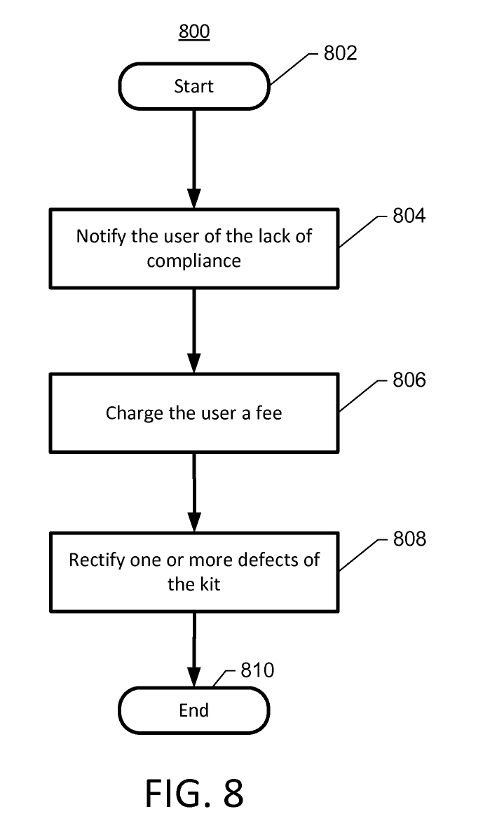

In response to determining that the kit as received failed to satisfy the one or more kit compliance criteria (e.g., exceeded the component compliance threshold), method 700 may proceed to 710, where kit accounting system 112 and/or kit management server 108 may be configured to initiate a remedial action, as discussed in greater detail in method 800 and FIG. 8. Method 700 may then end at 712.

In some embodiments, as discussed above, a remedial action may be initiated for reasons other than the kit as received failing to satisfy the component compliance threshold. For example, one or more components of the kit may be determined to be dirty, worn, broken, inoperable, or otherwise not in condition for recirculation. Here, the remedial action may include cleaning, repairing or otherwise replacing the one or more components, such that the kit lacks any unacceptable imperfections when sent to the next user. Additionally and/or alternatively, one or more replacement components may be provided. In other examples, remedial action may be initiated to replace an instruction manual, packaging, labels, or any other component that is provided to users with the kit.

In some embodiments, the spare components and/or spare component set as received may also be compared with a spare component compliance threshold. If the threshold is not satisfied, remedial action with respect to the spare components may be performed similar to the remedial action described herein for the components of the kit. For example, the user may receive a notification, may be charged a fee, the spare component set may be visually inspected, and/or replenished with replacement spare units before being placed in recirculation, among other things.

Returning to 708, in response to determining that the kit as received satisfied the one or more kit compliance criteria (e.g., failed to exceed the component compliance threshold), method 700 may proceed to 714, where kit accounting system 112 and/or kit management server 108 may be configured to determine a second kit from the user shipment queue of the user. For example, upon kit accounting system 112 determining that the kit was returned successful without requiring any remedial action, kit management server 108 may be notified. Furthermore, the user may be credited with the return and the system may associate a shipment-ready state with the user's account (e.g., at 508 of method 500). Furthermore, the second kit may be associated with the user for check out, and removed from the user shipment queue. Method 700 may then proceed to 712 and end.

Returning to 704, in response to determining that the kit was not received from the user, kit management server 108 may be configured to send a time-based reminder at 716 to the user device to return the kit. For example, kit management server 108 may be configured to monitor the shipping date and/or other relevant date(s) associated with the kit, and upon lapse of a predetermined period of time (such as 28 days), send a reminder message, which may be electronically sent to user device 106 and/or physical sent to the address associated with user device 106, wherein the reminder message informs the user that the kit may and/or should be returned. For example, an extra pre-paid postage return envelope may be sent to the user's address if there is an indication (explicit or implicit) suggesting the user may not have a pre-paid return envelope. In some embodiments, the notification may include instructions (including, e.g., a selectable option in the electronic message) for the user to purchase the kit, in which case the system can facilitate charging the user the full price of the kit and sending the next kit in the user's shipment queue to the user's physical address.

At 718, a determination can be made whether or not the process should continue to wait for the kit from the user. For example, when the user fails to respond to the message delivered at 716, the process may return to 704 and continue to wait and monitor for an indication of the kit's physical return from the user.

However, process 700 can proceed to 710 in response to determining that another reminder message about the checked out kit need not be sent to the user. For example, process 700 can proceed to 710 after a predetermined period of time, after sending a predetermined number of reminders to the user, after determining that the user will not return to the kit, after determining a contract or other legal provision enables the charging of the user for the kit, and/or for any other suitable reason.

FIG. 8 shows an example of a method for providing remedial action for a received kit, performed in accordance with some embodiments. For example, method 800 may be performed at 710 of method 700, such as in response to determining that the kit as received failed to satisfy the one or more kit compliance criteria (e.g., by failing to satisfy a component compliance threshold). Method 800 is described herein as being performed by kit accounting system 112 and kit management server 108. In some other embodiments, method 800 may be performed by kit management server108 (e.g., where kit accounting system 112 is not used), kit accounting system 112, and/or with any other suitable circuitry. In general, method 800 describes various remedial actions, some or all of which may be performed upon receiving a kit form the user that fails to meet the component compliance threshold (or one or more other thresholds, as discussed below).

Method 800 may begin at 802 and proceed to 804, where kit management server 108 may be configured to notify the user that the kit as received failed to satisfy the one or more kit compliance criteria, such as by exceeding the component compliance threshold. For example, the notification may be in the form of a message sent from kit management server 108 to user device 106 via network 104. In some embodiments, the notification may include accounting data indicating the amount of components missing, such as by weight, number of components, cost of missing components, and/or any other suitable metric. In general, the user may be notified of any defect and/or imperfection that exceeds the one or more kit compliance criteria. In some embodiments, one or more notification thresholds may be different from the component compliance threshold may be determined and the user may be notification based on whether the received kit exceeded the one or more notification thresholds. For example, a user may be notified regarding missing components even when the volume of missing components fails to exceed a component compliance threshold.

In some embodiments, kit management server 108 and/or kit accounting system 112 may be configured to generate a report. The report, for example, may be provided electronically and/or printed, such as by printer 220. The report may indicate one or more missing components (and/or other components of the kit) and may be utilized by an operator and/or circuitry to perform various remedial actions discussed herein.

At 806, kit management server 108 may be configured to charge the user a fee. For example, the amount of the fee may be based on one or more of the kit compliance criteria. In some embodiments, the user may be charged at various levels based on the amount that the one or more kit compliance thresholds are exceeded. For example, a full charge fee threshold may be set such that the user is charged for the cost of the kit if the user returned less than 10% of the units of the kit and/or one or more non-unit components. In some embodiments, the non-unit components may be assigned different levels of importance, and different remedial actions may be taken based on the importance level of the non-unit component needing replacing. For example, if an instruction manual is returned damaged such as to prevent future, the system may determine the instruction manual is a less important non-unit component and, in response, user may be provided a message indicating the state of the manual and the system may be configured to generate a new instruction manual. As another example, if doll is returned as damaged such that it cannot be used in the future, the system can be configured to determine the doll is an important non-unit component of the kit and, in response, charge the user for the cost of the doll (i.e., the damaged non-unit component).

In some embodiments, the amount of the fee may depend on, among other things, the subscription level of the user. For example, a higher subscription level may allow the user to be charged a lesser fee for a particular level of kit defects and/or imperfections of a returned kit as compared to a lower subscription level. In another example, each user may be given an allowance for a predetermined period of time (e.g., monthly, quarterly, yearly, etc.) for which they are not charged for rectifying kit defects and/or imperfections until exceeding the allowance. Furthermore, different subscription levels may be associated with different allowance levels.

At 808, kit management server 108 and/or kit accounting system 112 may be configured to rectify one or more defects of the kit. For example, the one or more missing components determined at 708 of method 700 may be replaced with one or more replacement components. Kit accounting system 112 may be configured to generate a missing component list or the like that can be used to acquire the one or more replacement components from kit delivery system 114 (e.g., where the replacement components are determined to be available in inventory) and/or a manufacturer of the kit. Other example remedial actions for rectifying defects may include cleaning and/or replacing worn components, instruction manuals, labels, packaging.

In some embodiments, the kit may be removed from circulation and held until remedial action is completed for the one or more defects. Kit management server 108 and/or kit accounting system 112 may be configured to send an order to the manufacturer of the kit for the one or more replacement components, such as in response to determining that a replacement component is not in inventory (e.g., by accessing spare component data in spare component database 218). Furthermore, in some embodiments, kit management server 108 may be configured to receive an indication from user device 106 that the kit (e.g., in the user's possession) is missing one or more components. Here, kit management server 108 may be configured to generate and/or send the order to the manufacture for the one or more replacement components. The one or more replacement components may be sent to the user directly from the manufacture or via directly to the user or via kit delivery system 114. In some embodiments, rather than replacing components of a kit and/or spare component set, the kit and/or spare component set may be removed from inventory or otherwise not offered for recirculation.

In some embodiments, combinations of remedial actions described at 804-808 may be performed. For example, the user may be charged a fee based on the cost of one or more missing components and/or the based on the cost of one or more replacement components. Furthermore, the user may be notified regarding the amount of the fee and/or whether replacement components are available (e.g., upon receiving a user request for replacement components). In some embodiments, remedial actions may be associated with different kit compliance criteria and/or component compliance thresholds. For example, exceeding the lowest component compliance threshold may only result in a notification and/or warning, while exceeding a higher component compliance threshold may result in a fee and/or other remedial action. In some embodiments, different components may have different component compliance thresholds. For example, components deemed important (e.g., expensive to replace) may have a lower component compliance threshold, whereas components deemed less important may have a higher component compliance threshold. Method 800 may then end at 810.

FIG. 9 shows an example of a method 900 for replacing components of a kit, performed in accordance with some embodiments. Method 900 may be performed by kit accounting system 112 to provide an automated technique for backend kit collection, accounting, and remedial action, such as upon a kit being received from the user following the kit being in the user's possession. Method 900 may be used to replace unit components, non-unit components, and/or combinations or unit and non-unit components of a kit.

Method 900 may begin at 902 and proceed to 904, where kit accounting apparatus 202, via kit input 204, may be configured to receive at least a portion of components of the kit as returned. For example, the received kit may be removed from the return packaging of the kit. The barcode data on the packaging (e.g., the return shipping label) may be scanned and/or the received kit may be otherwise identified (e.g., via RFID, kit identification number, etc.). Next, the components of the kit returned from the user (e.g., the at least a portion of the components of the kit) may be input to kit input 204. In some embodiments, where the components include building blocks, received building blocks that are interconnected may be separated before being received at kit input 204 to aid in the accounting process.

At 906, circuitry 210 of kit accounting apparatus 202 may be configured to access kit data indicating the components of the kit. For example, the kit data may be stored in kit database 216. Circuitry 210 may be configured to query kit database 216, such as based on the kit identification number.

At 908, circuitry 210 may be configured to determine that one or more components are missing from the kit as returned based on the at least a portion of the components of the kit and the kit data. For example, kit accounting apparatus 202 may include one or more sensors 212 configured to determine one or more component defining characteristics and quantity of components for the at least a portion of the components of the kit. In some embodiments, sensors 212 may include one or more optical, electromagnetic, RFID, and/or weight sensors for detecting the component defining characteristics. Circuitry 210 may be configured to receive sensor data generated by sensors 212 and to determine the one or more missing components based on the sensor data. Some example component defining characteristics captured in the sensor data may include one or more of the size, color, shape, and/or functionality of the components. In some embodiments, the one or more missing components may be sent to kit management server 108, such as for comparison with one or more component compliance thresholds and/or for remedial action when appropriate.

At 908, circuitry 210 may be configured to associate one or more replacement components with the kit. The one or more replacement components may correspond with the one or more missing components from the received kit such that the one or more replacement components, when added to the received kit, may provide for a complete kit. In some embodiments, received kits may only receive replacement components upon exceeding a component compliance threshold, replacement component threshold, or the like.

In some embodiments, circuitry 210 may be configured to access spare component database 218 to determine whether the one or more replacement components are available in inventory. If the replacement components are unavailable, circuitry 210 and/or kit management server 108 may be configured to generate an order for the unavailable replacement components with the manufacturer. If the replacement components are available, they may be associated with the kit and removed from the replacement component inventory.

At 912, kit accounting apparatus 202 may be configured to receive the one or more replacement components. For example, the one or more replacement components may be received at component input 206 from component inventory 214. Circuitry 210 may be configured to control component input 206 to receive the one or more replacement components. In some embodiments, circuitry 210 may generate a list of replacement components to facilitate physical retrieval from component inventory 214.

At 914, kit accounting apparatus 202 may be configured to provide the kit including the at least one portion of the components of the kit (e.g., as received from the user) and the one or more replacement components. For example, the complete kit can be output to kit output 208. In some embodiments, kit accounting apparatus 202 may be further configured to replacing spare components of a spare component set. For example, the received spare component set may be input at kit input 204, one or more missing spare components may be determined, one or more replacement spare components may be received at component input 206, and a complete spare component set may be provided at kit output 208. Furthermore, in some embodiments, remedial action for missing spare components may be provided using similar techniques and/or in combination with the remedial actions discussed herein for missing components in a kit. In some embodiments, kit accounting apparatus 202 may be further configured to provide remedial action for non-unit components such as instruction manuals, labels, packaging, etc., including replacing a non-unit component, notifying the user, and/or charging the user a fee. Method 900 may then end at 916.

### CONCLUSION

Many modifications and other embodiments will come to mind to one skilled in the art to which these embodiments pertain having the benefit of the teachings presented in the foregoing descriptions and the associated drawings. For example, the techniques discussed herein involving a commercial context may easily be extended to other contexts by a person of skill in the art. Therefore, it is to be understood that embodiments and implementations are not to be limited to the specific example embodiments disclosed and that modifications and other embodiments are intended to be included within the scope of the appended claims. Although specific terms are employed herein, they are used in a generic and descriptive sense only and not for purposes of limitation.

1. A system configured to inventory multi-component kits, comprising:
a networked device with circuitry configured to:
determine a weight of a kit prior to shipping the kit to a user, wherein the kit includes a plurality of individual pieces configured to be removably coupled to each other;
determine that the kit has been received subsequent to the kit being shipped to a user;
in response to determining that the kit has been received after being shipped to the user:
determine a weight of the kit as received from the user;
determine a weight difference between the weight of the kit prior to shipping to the user and the weight of the kit as received from the user;
determine a unit compliance threshold, wherein the unit compliance threshold defines a minimum value for the weight difference that is needed to initiate a remedial action;
determine whether the kit as received exceeds the unit compliance threshold based at least in part on a comparison of the weight difference and the unit compliance threshold; and
in response to determining the kit as received exceeds the unit compliance threshold, initiate a remedial action, wherein the remedial action includes notifying the user that the kit as received exceeded the unit compliance threshold.

2. The system of claim 1, wherein the circuitry configured to determine whether the kit as received exceeds the unit compliance threshold further includes the circuitry being configured to determine whether the kit as received exceeds the unit compliance threshold based at least in part on number of units included in the kit as sent and number of units included in the kit as received.

3. The system of claim 1, wherein the remedial action includes one or more of:
charging the user a fee;
charging the user a fee based on the cost of one or more missing units;
charging the user a fee based on the cost of one or more replacement units;
sending an order to a manufacturer of the kit for one or more replacement units; and
associating one or more replacement units with the kit.

4. The system of claim 1, wherein the circuitry is further configured to associate the kit with one or more of: barcode data, a kit identification number, a user identification number, a shipping date, and a shipping weight of the kit.

5. The system of claim 1 further comprising a kit accounting apparatus including:
a kit input configured to receive at least a portion of units of the kit; and
kit accounting circuitry configured to determine that one or more units are missing from the kit as returned based on the at least a portion of the units of the kit received by the kit input.

6. The system of claim 5, wherein:
the kit accounting apparatus further includes:
one or more unit inputs configured to receive one or more replacement units; and
a kit output configured to provide the units of the kit including the one or more replacement units; and
the kit accounting circuitry is further configured to:
determine the one or more replacement units by accessing kit data indicating the units of the kit; and
associate the one or more replacement units with the kit after determining the one or more replacement units.

7. The system of claim 5, wherein:
the kit accounting apparatus further includes one or more sensors configured to determine one or more unit defining characteristics and quantity of units for the at least a portion of the units of the kit; and
the kit accounting circuitry is further configured to determine that the one or more units are missing from the kit as returned based on the unit defining characteristics and the quantity of units.

8. The system of claim 7, wherein:
the one or more unit inputs are further configured to receive the units of the kit;
the kit accounting circuitry is further configured to:
access kit data indicating the units of the kit; and
control the one or more unit inputs based on the kit data; and
the kit output is further configured to provide the units of the kit received from the one or more unit inputs.

9. The system of claim 1, wherein the circuitry is further configured to:
receive an indication from a user device associated with the user that the kit is missing one or more units; and
send an order to the manufacturer of the kit for the one or more units.

10. The system of claim 1, wherein the circuitry is further configured to, in response to determining that the kit has been received:
determine whether an instruction manual for the kit is missing from the kit; and
associate a second instruction manual with the kit after determining that the instruction manual is missing from the kit.

11. The system of claim 1, wherein at least some of the units are building blocks.

12. A machine-implemented method for inventorying multi-component kits, comprising:
determining, by circuitry, a weight of a kit prior to shipping the kit to a user, wherein the kit includes a plurality of individual pieces configured to be removably coupled to each other;
determining, by the circuitry, that the kit has been received subsequent to the kit being shipped to a user; and
in response to determining that the kit has been received after being shipped to the user:
determining, by the circuitry, a weight of the kit as received from the user;
determining, by the circuitry, a weight difference between the weight of the kit prior to shipping to the user and the weight of the kit as received from the user;
determining, by the circuitry, a unit compliance threshold, wherein the unit compliance threshold defines a minimum value for the weight difference that is needed to initiate a remedial action;
determining, by the circuitry, whether the kit as received exceeds the unit compliance threshold based at least in part on a comparison of the weight difference and the unit compliance threshold; and
in response to determining the kit as received exceeds the unit compliance threshold, initiating a remedial action by the circuitry, wherein the remedial action includes notifying the user that the kit as received exceeded the unit compliance threshold.

13. The method of claim 12, wherein determining, by the circuitry, whether the kit as received exceeds the unit compliance threshold includes determining whether the kit as received exceeds the unit compliance threshold based on number of units included in the kit as sent and number of units included in the kit as received.

14. The method of claim 12, wherein the remedial action includes one or more of:
charging the user a fee;
charging the user a fee based on the cost of one or more missing units;
charging the user a fee based on the cost of one or more replacement units;
sending an order to a manufacturer of the kit for one or more replacement units; and
associating one or more replacement units with the kit.

15. The method of claim 12 further comprising associating, by the circuitry, the kit with one or more of: barcode data, a kit identification number, a user identification number, a shipping date, and a shipping weight of the kit.

16. The method of claim further comprising:
receiving at least a portion of units of the kit; and
determining, by the circuitry, that one or more units are missing from the kit as returned based on the at least a portion of the units of the kit.

17. The method of claim 16 further comprising:
determining, by the circuitry, one or more replacement units by accessing kit data indicating the units of the kit;
associating, by the circuitry, the one or more replacement units with the kit after determining the one or more replacement units;
receiving the one or more replacement units; and
providing the units of the kit including the one or more replacement units.

18. The method of claim 16 further comprising:
receiving, by the circuitry, one or more unit defining characteristics and quantity of units for the at least a portion of the units of the kit; and
determining, by the circuitry, that the one or more units are missing from the kit as returned based on the unit defining characteristics and the quantity of units.

19. The method of claim 18 further comprising:
accessing, by the circuitry, kit data indicating the units of the kit;
receiving the units of the kit from one or more unit inputs of a kit accounting apparatus; and
providing the units of the kit received from the one or more unit inputs.

20. The method of claim 12 further comprising:
receiving, by the circuitry, an indication from a user device associated with the user that the kit is missing one or more units; and
sending, by the circuitry, an order to the manufacturer of the kit for the one or more units.

21. The method of claim 12 further comprising:
determining whether an instruction manual for the kit is missing from the kit; and
associating a second instruction manual with the kit after determining that the instruction manual is missing from the kit.

22. The method of claim 12, wherein at least some of the units are configured to mechanically couple to each other.

23. A computer program product comprising a non-transitory computer readable storage medium and computer program instructions stored therein, the computer program instructions comprising program instructions for:
determining, by circuitry, a weight of a kit prior to shipping the kit to a user, wherein the kit includes a plurality of individual pieces configured to be removably coupled to each other;
determining, by the circuitry, that the kit has been received subsequent to the kit being shipped to a user; and
in responsive to determining that the kit has been received after being shipped to the user:
determining, by the circuitry, a weight of the kit as received from the user;
determining, by the circuitry, a weight difference between the weight of the kit prior to shipping to the user and the weight of the kit as received from the user;
determining, by the circuitry, a unit compliance threshold, wherein the unit compliance threshold defines a minimum value for the weight difference that is needed to initiate a remedial action;
determining, by the circuitry, whether the kit as received exceeds the unit compliance threshold based at least in part on a comparison of the weight difference and the unit compliance threshold; and
in response to determining the kit as received exceeds the unit compliance threshold, initiating a remedial action by the circuitry, wherein the remedial action includes notifying the user that the kit as received exceeded the unit compliance threshold.

24. The system of claim 1, wherein the circuitry configured to initiate the remedial action includes the circuitry being configured to:
determine a fee amount based on the weight difference between the weight of the kit prior to shipping to the user and the weight of the kit as received from the user; and
charge the user the fee amount only when the weight difference exceeds the unit compliance threshold, wherein the unit compliance threshold defines a non-zero minimum value such that the user is not charged for a non-zero weight difference that fails to exceed the non-zero minimum value.

25. The method of claim 12, wherein initiating the remedial action includes:
determining a fee amount based on the weight difference between the weight of the kit prior to shipping to the user and the weight of the kit as received from the user; and
charging the user the fee amount only when the weight difference exceeds the unit compliance threshold, wherein the unit compliance threshold defines a non-zero minimum value such that the user is not charged for a non-zero weight difference that fails to exceed the non-zero minimum value.
